(19) United States
(12) Patent Application Publication
(10) Pub. No.: US 2025/0309556 A1
(43) Pub. Date: Oct. 2, 2025

(54) ARRAY-FED REFLECTOR ANTENNA, AND SIGNAL PROCESSING DEVICE AND SIGNAL PROCESSING METHOD FOR ARRAY-FED REFLECTOR ANTENNA

(71) Applicant: Mitsubishi Electric Corporation, Tokyo (JP)

(72) Inventors: Naoya NOGUCHI, Tokyo (JP); Shinichi YAMAMOTO, Tokyo (JP); Tai TANAKA, Tokyo (JP)

(73) Assignee: Mitsubishi Electric Corporation, Tokyo (JP)

(21) Appl. No.: 19/239,756

(22) Filed: Jun. 16, 2025

Related U.S. Application Data
(63) Continuation of application No. PCT/JP2023/004273, filed on Feb. 9, 2023.

(51) Int. Cl. H01Q 15/16; H01Q 3/26; H04B 7/06; H04B 7/08

(52) U.S. Cl. CPC H01Q 15/16; H01Q 3/26; H04B 7/06; H04B 7/08

(57) ABSTRACT

A signal processing device for an array-fed reflector antenna according to the technology of the present disclosure is a signal processing device for an array-fed reflector antenna of a DBF system, and includes an excitation coefficient computation unit, the excitation coefficient computation unit executes a DBF algorithm on an assumption that all element antennas connected to an array-fed unit are used, and calculates an excitation coefficient for each of the element antennas, and the excitation coefficient computation unit selects an element antenna that greatly contributes to a beam among the element antennas on the basis of a numerical value of the excitation coefficient.

### CROSS REFERENCE TO RELATED APPLICATION

This application is a Continuation of PCT International Application No. PCT/JP2023/004273, filed on Feb. 9, 2023, which is hereby expressly incorporated by reference into the present application.

### TECHNICAL FIELD

The technology of the present disclosure relates to an array-fed reflector antenna, and a signal processing device and a signal processing method for the array-fed reflector antenna.

### BACKGROUND ART

The array-fed reflector antenna has a structure formed by combining a reflector antenna and an array antenna that is used as a primary radiator of the reflector antenna. The array-fed reflector antenna is used as, for example, an antenna mounted on a satellite that implements multibeam satellite communication.

For example, Patent Literature 1 discloses an array-fed reflector antenna that can scan a beam in a wide range.

### CITATION LIST

### Patent Literature

Patent Literature 1: WO 2014/073222 A

### SUMMARY OF INVENTION

### Technical Problem

Patent Literature 1 describes that, although this is for element antennas of a limited range, element antennas whose excitation amplitudes are small may be excluded to reduce the number of connection elements to be connected to a transceiver. As described above, an idea that an influence on entirety given by the element antennas of the small excitation amplitudes is negligibly little and is approximated is considered to be nothing new.

However, Patent Literature 1 does not adopt reduction of the number of connection elements as a main theme, and does not clarify a specific configuration for effectively implementing this reduction.

The technology of the present disclosure adopts reduction of the number of connection elements as a main theme, and clarifies a specific configuration for effectively implementing this reduction.

### Solution to Problem

A signal processing device for an array-fed reflector antenna according to the technology of the present disclosure is a signal processing device for an array-fed reflector antenna of a DBF system, and includes an excitation coefficient calculator, wherein on an assumption that all element antennas connected to an array feeder are used, the excitation coefficient calculator executes a DBF algorithm for all of the element antennas, and calculates an excitation coefficient for each of the element antennas, wherein the excitation coefficient calculator selects an element antenna that greatly contributes to a beam among the element antennas on a basis of a numerical value of the excitation coefficient, and wherein specifically, the excitation coefficient calculator compares a difference between numerical values of neighboring excitation coefficients and a threshold (εw) with the element antennas arranged in descending order of numerical values of excitation coefficients, and selects an element antenna that satisfies a following conditional expression

$${W}_{Low} := \{ \begin{matrix}{w}_{1} & … & {w}_{{N}_{low}}\end{matrix} \} \qquad ( 5 )$$

$$wherein$$

$$for n = 1 to {N}_{Low} - 1$$

$$\vert {w}_{n} \vert - \vert {w}_{n + 1} \vert < {ε}_{w}$$

$$and$$

$$\vert {w}_{{N}_{Low}} \vert - \vert {w}_{{N}_{Low} + 1} \vert \geq {ε}_{w}$$

among the element antennas.

### Advantageous Effects of Invention

Since a signal processing device for an array-fed reflector antenna according to the technology of the present disclosure employs the above configuration, a specific configuration of reducing the number of connection elements is clear.

### BRIEF DESCRIPTION OF DRAWINGS

FIG. 1 is a block diagram illustrating a configuration in a case where an array-fed reflector antenna according to Embodiment 1 is a transmission antenna.

FIG. 2 is a block diagram illustrating a configuration in a case where the array-fed reflector antenna to Embodiment 1 is a reception antenna.

FIG. 3 is a view for describing an operation principal of the array-fed reflector antenna.

FIG. 4 is a flowchart illustrating processing steps related to signal processing of the array-fed reflector antenna according to Embodiment 1.

FIG. 5 is a block diagram for describing a function of an excitation coefficient computation unit 150 constituting the array-fed reflector antenna according to Embodiment 1.

FIG. 6 is an explanatory view of an array-fed unit 110 illustrating a distribution of element antennas 111 obtained by classifying the element antennas 111 on the basis of the magnitude of amplitude scaling.

FIG. 7 is an explanatory view of processing of selecting the element antenna 111 that greatly contributes to an entire beam on the basis of the magnitude of amplitude scaling.

FIG. 8 shows a bar graph for describing a signal processing method of an array-fed reflector antenna according to Embodiment 2.

FIG. 9 shows a bar graph for describing a signal processing method of an array-fed reflector antenna according to Embodiment 3.

FIG. 10 shows a bar graph for describing a signal processing method of an array-fed reflector antenna according to Embodiment 5.

### DESCRIPTION OF EMBODIMENTS

### (Introduction Digital Beam Forming)

According to Digital Beam Forming (hereinafter, referred to as “DBF”), it is known that reception beam formation processing of a microwave circuit based on a phased array system is performed by digital signal processing. An antenna system that adopts DBF includes an analog-to-digital converter that is provided in each element antenna and converts a received signal into a digital signal. In a case where DBF is adopted, phase shift, amplitude scaling, and received signal synthesis performed by a phase shifter of a phased array antenna or the like are replaced with multiplication of a complex weight on a received digital signal and addition of multiplication results. Here, a complex weight (wₙ) is more specifically expressed by a following mathematical formula.

$$for n = 1 to N \qquad ( 1 )$$

$${\overbrace{{w}_{n}}}^{c omplex w eight} := {\overbrace{{a}_{n} {e}^{- j {ϕ}_{n}}}}^{∈ ℂ}$$

In this regard, N represents a total number of element antennas, and j represents an imaginary number unit. Furthermore, a represents a parameter related to amplitude scaling, and φ represents a parameter related to phase shift. As indicated the equation (1), the complex weight (wₙ) is a complex number.

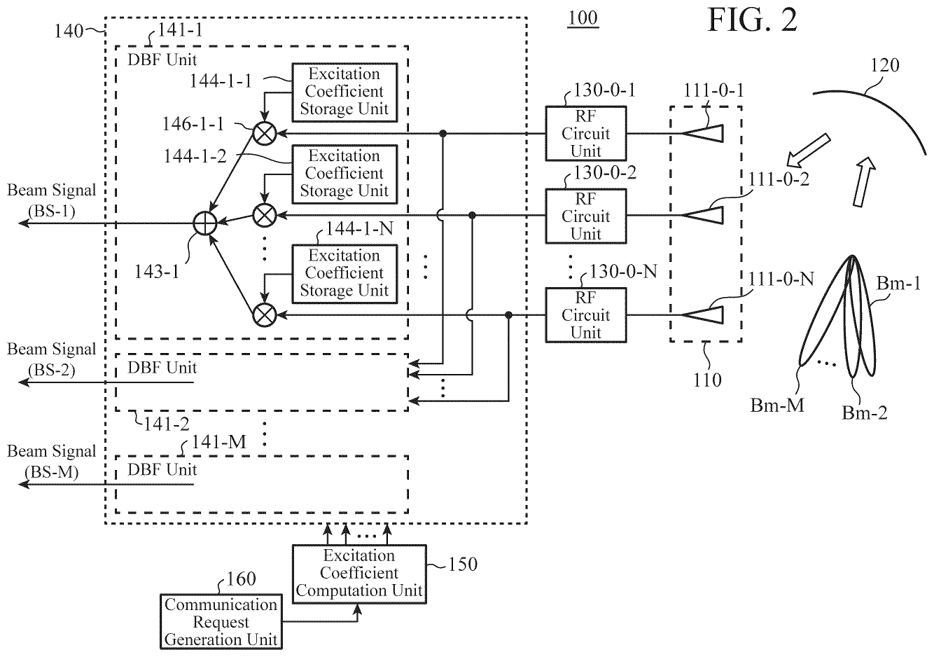

Note that, in a case where a plurality of beam signals are output by parallel processing of different signal processing, that is, in a case where there are a plurality of (M) beam signals to be output, the N complex weights (wₙ) are used for each beam signal, and M×N complex weights (wₙ) are used in total (see FIG. 2 according to Embodiment 1).

There are mainly three advantages of an antenna system that adopts DBF (hereinafter, referred to as a “DBF system”). The first advantage is that it is possible to scan a beam at an ultra high speed by using high-speed digital computation. The second advantage is that it is possible to control a complex weight in a detailed manner, and consequently it is possible to perform detailed antenna pattern shaping such as ultra-side lobe reduction. The third advantage is that it is easy to execute a plurality of beam formation computations of different orientation directions by digital computation in parallel. Note that an arithmetic equation has a form of Fourier transform from position coordinates of an antenna element into a beam formation angle.

As described above, matters described in “Introduction Digital Beam Forming” are mainly recitations from the following reference document (Section 5.1 in particular).

Reference Document: “Basics of Radar—from Exploration Radar to Synthetic Aperture Radar—” written and edited by Kazuo Ouchi, CORONA PUBLISHING CO., LTD., first copy of first edition is published in 2017, ISBN978-4-339-00894-4.

Note that, although a case where DBF is applied to a reception antenna is described in “Introduction Digital Beam Forming”, DBF is also applicable to a transmission antenna.

### Embodiment 1

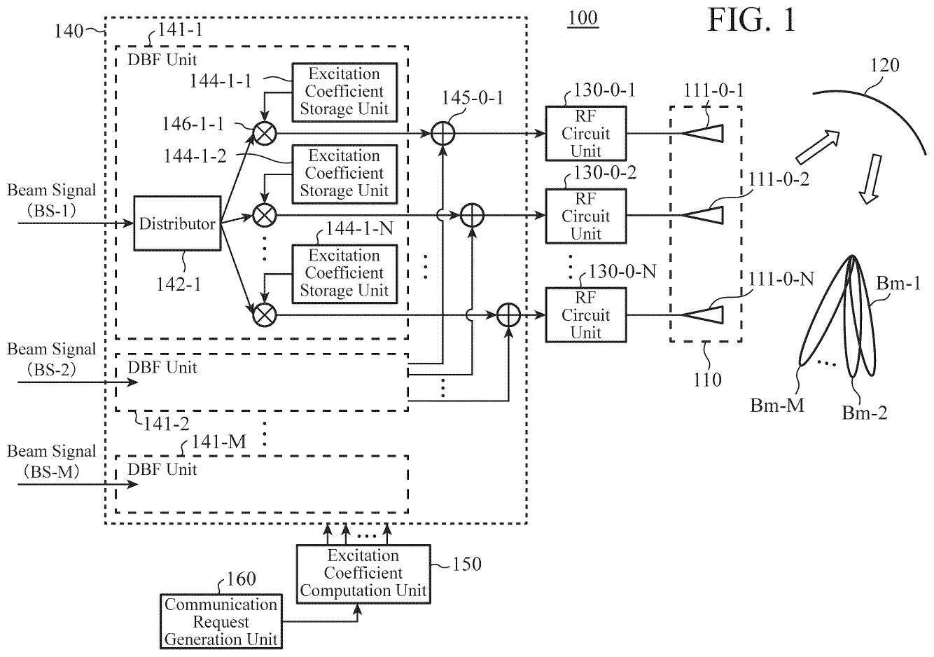

FIG. 1 is a block diagram illustrating a configuration in a case where an array-fed reflector antenna 100 according to Embodiment 1 is a transmission antenna. Furthermore, FIG. 2 is a block diagram illustrating a configuration in a case where the array-fed reflector antenna 100 according to Embodiment 1 is a reception antenna. A difference between FIGS. 1 and 2 is that directions of signals are different, and there is no other substantial difference.

As illustrated in FIGS. 1 and 2, the array-fed reflector antenna 100 according to Embodiment 1 includes an array-fed unit 110, a reflector unit 120, an RF circuit 130, a signal processing unit 140, an excitation coefficient computation unit 150, and a communication request generation unit 160.

Here, meanings of reference numerals used in this description and the drawings are as follows.

TABLE 1

| | | n : nth element |
|---|---|---|
| | | ↑ |
| ### − | m − | n |

| | |
|---|---|
| reference | ↓ |
| numeral | m : mth beam signal |
| | 0 : all beam signals |

As shown in Table 1, “###” at a head is a reference numeral assigned to each component. In a case where, for example, “###” is “111”, “111” means an element antenna 111. Furthermore, second “m” is a symbol that indicates an mth beam signal, or all beam signals when 0 is substituted in m. m takes a natural number from 1 to M. Note that {“Bm-1”, “Bm-2”, . . . , “Bm-M”} illustrated in FIG. 1 each indicate a beam. FIG. 1 illustrates a beam corresponding to a beam signal. “n” at a tail represents a symbol that indicates an nth element. n takes a natural number from 1 to N. Note that second “m” and “n” at the tail may be omitted.

As illustrated in FIG. 1, the array-fed unit 110 is connected with the N element antennas 111 (111-0-1 to 111-0-N). When the array-fed reflector antenna 100 is the transmission antenna, the element antenna 111 is a radiation element. The array-fed unit 110 functions as a primary radiator of the reflector unit 120.

As the reflector unit 120, a reflector having a concave surface is used, and a parabolic mirror surface is typically and usually used.

As illustrated in FIG. 1, the array-fed reflector antenna 100 according to Embodiment 1 includes the N RF circuits 130 (130-0-1 to 130-0-N). RF in the name of the RF circuit 130 derives from initials of Radio Frequency. RF generally refers to various frequency ranges from around 300 [Hz] (extremely low frequency) to around 3 [Thz] (submillimeter wave).

The RF circuit 130 generally includes devices such as a digital-to-analog-to-digital converter, an amplifier, a filter, and an up-converter.

As illustrated in FIG. 1, the signal processing unit 140 is a component that performs multi-input multi-output signal processing. An input of the signal processing unit 140 is M beam signals (BS-1 to BS-M). Furthermore, an output of the signal processing unit 140 is connected to the N RF circuits 130 (130-0-1 to 130-0-N).

In FIGS. 1 and 2, the signal processing unit 140 is illustrated as a form including M DBF units 141 (141-1 to 141-M). This schematizes that parallel processing is performed by different signal processing, and is a devise for the sake of description. The actual signal processing unit 140 may include a single processing circuit that performs digital signal processing, and does not need to include a plurality of processing circuits.

The excitation coefficient computation unit 150 is a component that computes an excitation coefficient as the name thereof indicates. The excitation coefficient may be considered as a complex weight (wₙ) that appears in Introduction. Details of the excitation coefficient will be made apparent from description described later.

The above-described DBF unit 141 (141-1 to 141-M) is merely a component that includes “DBF” in the name, multiplies the given complex weight (wₙ) on a signal, and adds (or subtracts) a multiplication result. A component that actually calculates the complex weight (wₙ) related to DBF is the excitation coefficient computation unit 150.

The communication request generation unit 160 is a component that requests a designed radiation pattern in a designed direction of each beam. This request will be referred to as a “communication request” in this description. In other words, the communication request generation unit 160 is a component that generates a communication request.

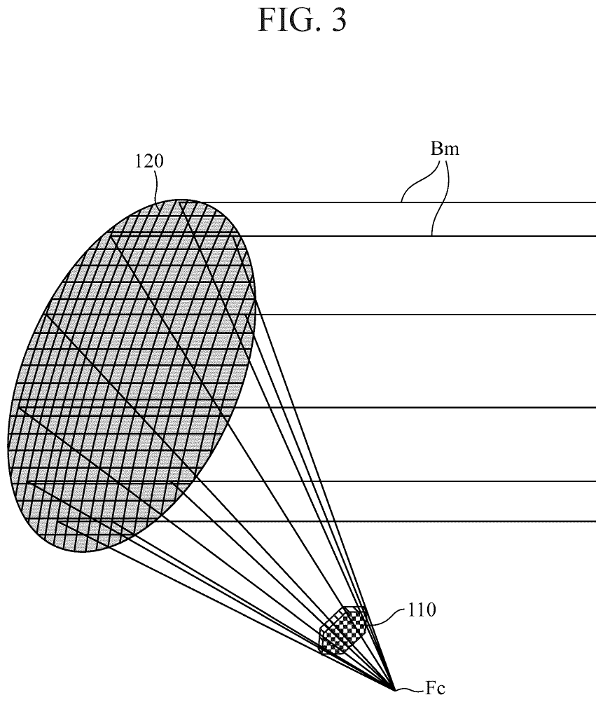

FIG. 3 is a view for describing an operation principal of the array-fed reflector antenna 100. “Fc” in FIG. 3 represents a focus of the reflector unit 120. Furthermore, “Bm” represents a beam. FIG. 3 illustrates a case where the reflector unit 120 is a parabolic mirror surface, and a beam (Bm) emitted from the focus (Fc) becomes a parallel beam that travels toward a boresight direction of the reflector unit 120 via the reflector unit 120.

As illustrated in FIG. 3, the plurality of element antennas 111 connected to the array-fed unit 110 are aligned in a two-dimensional pattern.

As for a design matter regarding at what position the array-fed unit 110 needs to be installed, a style of replacing a radio wave with a parallel beam to consider is easy to understand. The array-fed unit 110 needs to be installed at such a position that, at least when a parallel beam coming from a direction of interest enters the reflector unit 120, reflection light of the reflector unit 120 can be received. When an installation position of the array-fed unit 110 approaches the focus (Fc), a range of reflection light to be projected on a light reception surface of the array-fed unit 110 narrows.

An array-fed reflector antenna including the focus (Fc) on the light reception surface of the array-fed unit 110 will be referred to as a “focal plane array-fed reflector antenna”. The array-fed reflector antenna whose light reception surface of the array-fed unit 110 is separated from the focus (Fc) will be referred to as a “defocus array-fed reflector antenna”. When seen from the reflector unit 120, a direction to move the light reception surface of the array-fed unit 110 away from the focus (Fc) may be any one of a direction to move the array-fed unit 110 closer to the reflector unit 120 than the focus (Fc) or a direction to move the array-fed unit 110 farther away from the reflector unit 120 than the focus (Fc).

Here, the boresight direction of the reflector unit 120 is represented by Do, and a certain direction of interest different from the boresight direction (D₀) is represented by D₁. It is assumed that a parallel beam whose direction is D₁ enters the reflector unit 120 in a direction traveling toward the reflector unit 120. The parallel beam is reflected by an outline of a mirror surface of the reflector unit 120, and a range to be projected on the light reception surface of the array-fed unit 110 can be specified as a range associated with D₁ (hereinafter, referred to as a “D₁ associated range”). The element antennas 111 included in the D₁ associated range are grouped and will be referred to as an “element antenna group” to be associated with D₁. In a case where still another direction is represented by D₂, it is possible to specify a D₂ associated range different from the D₁ associated range, and define an “element antenna group” to be associated with D₂. A method of replacing a radio wave with a parallel beam and selecting an element will be also referred to as a “geometrical-optical element selection method”. Note that an element antenna group may eventually include only one element.

In a case where an element antenna group associated with D₁ is a radiation element, it is ideally possible to provide a beam whose direction is D₁. An operation principal in a case where the array-fed reflector antenna is a transmission antenna is to perform excitation so as to form an excitation distribution using a plurality of element antenna groups, and thereby form a beam of a radiation pattern designed in a desired direction. Thus, it can be said that the operation principal of the array-fed reflector antenna is based on the superposition principle.

An advantage of the focal plane array-fed reflector antenna is that it is possible to reduce the number of element antennas belonging to an element antenna group to be associated with one direction. On the other hand, in a case of the defocus array-fed reflector antenna, the number of element antennas belonging to an element antenna group becomes large. The larger number of element antennas belonging to an element antenna group means that, even when, for example, one of RF circuits connected to an element antenna causes a failure, an influence on overall performance is little. Furthermore, the large number of element antennas belonging to an element antenna group means that the degree of freedom for a radiation pattern increases, and a beam can be flexibly formed.

The technology of the present disclosure is applicable to both of the focal plane array-fed reflector antenna, and the defocus array-fed reflector antenna.

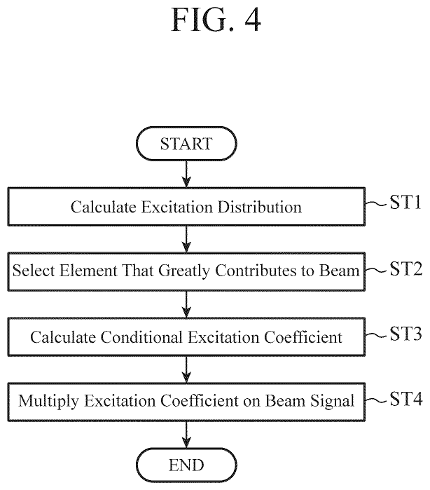

FIG. 4 is a flowchart illustrating processing steps related to signal processing of the array-fed reflector antenna 100 according to Embodiment 1. As illustrated in FIG. 4, the processing steps related to the signal processing of the array-fed reflector antenna 100 include “calculation of an excitation distribution (ST1)”, “selection of an element that greatly contributes to a beam (ST2)”, “calculation of a conditional excitation coefficient (ST3), and “multiplication of an excitation coefficient on a beam signal (ST4)”.

Here, the flowchart illustrated in FIG. 4 indicates processing steps in a case where the array-fed reflector antenna 100 is the transmission antenna (see FIG. 1).

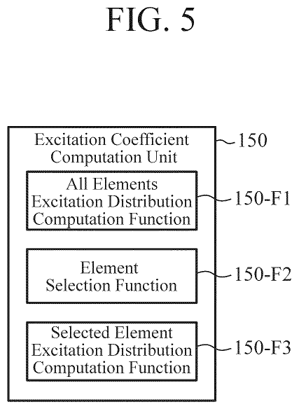

FIG. 5 is a block diagram for describing three functions of the excitation coefficient computation unit 150 constituting the array-fed reflector antenna 100 according to Embodiment 1. As illustrated in FIG. 5, the excitation coefficient computation unit 150 has an all elements excitation coefficient computation unit (150-F1), an element selection function (150-F2), and a selected element excitation coefficient computation unit (150-F3).

“Calculation of the excitation distribution (ST1)” is mainly a processing step performed by the communication request generation unit 160 and the excitation coefficient computation unit 150.

The communication request generation unit 160 functions as a man machine interface that transmits a design direction and a design radiation pattern to a signal processing device of the array-fed reflector antenna 100 to provide a radiation pattern (hereinafter, referred to as a “design radiation pattern”) designed by a user in a direction designed by the user (hereinafter, referred to as a “design direction”) at a time of “calculation of the excitation distribution (ST1)”.

At the time of “calculation of the excitation distribution (ST1)”, the excitation coefficient computation unit 150 that has acquired the design direction and the design radiation pattern from the communication request generation unit 160 first executes a DBF algorithm as conventionally performed and calculates a complex weight (w_{m,n}).

$$for m = 1 to M \qquad ( 2 )$$

$$for n = 1 to N$$

$${w}_{m , n} := {\overbrace{{a}_{m , n} {e}^{- j {ϕ}_{m , n}}}}^{∈ ℂ}$$

The complex weight (w_{m,n}) defined in the equation (2) will be also referred to as an excitation coefficient.

The conventional DBF algorithm first performed by the excitation coefficient computation unit 150 is executed on an assumption that the all element antennas 111 connected to the array-fed unit 110 are used. This processing step is performed by the all elements excitation coefficient computation function (150-F1) of the excitation coefficient computation unit 150.

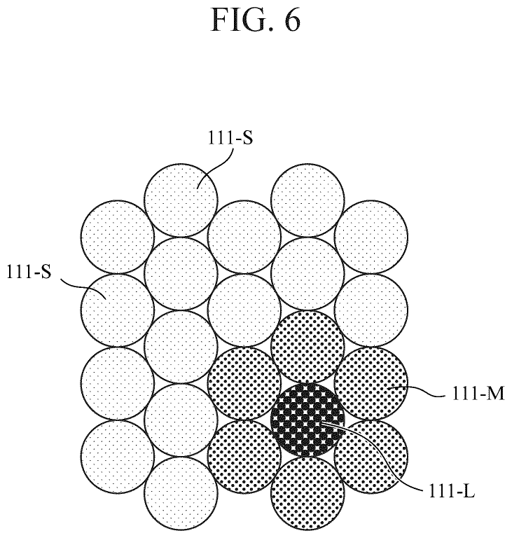

“Selection of the element that greatly contributes to the beam (ST2)” is mainly a processing step performed by the excitation coefficient computation unit 150. The meaning of “contribution to the beam” will be made apparent from following description made with reference to FIG. 6.

FIG. 6 is an explanatory view of the array-fed unit 110 illustrating a distribution of the element antennas 111 obtained by classifying the element antennas 111 on the basis of a magnitude of amplitude scaling. Although FIG. 6 illustrates 22 neighboring circles, each circle represents the element antenna 111. That is, in an example in FIG. 6, the total number (N) of the element antennas 111 connected to the array-fed unit 110 is 22.

For simplicity of description, the description assumes that a beam signal is only a first beam signal (m=1 and M=1). For each of the 22 element antennas 111 illustrated in FIG. 6, the one complex weight (w_{m,n}) is calculated by the all elements excitation distribution computation function (150-F1).

As indicated in the equation (2), the complex weight (w_{m,n}) includes a_{m,n} related to amplitude scaling and φ_{m,n} related to phase shift. a_{m,n} related to amplitude scaling takes a positive value, and is equal to an absolute value (a distance from an origin of the complex plane) of the complex weight (w_{m,n}) that is a complex number. In this description, the absolute value of the complex weight (w_{m,n}) that is a complex number is paraphrased simply as a phrase “a numerical value of an excitation coefficient” for simplicity of description.

In an example illustrated in FIG. 6, numerical values of excitation coefficients are classified into three ranges (L, M, and S), and the element antennas 111 are classified into three groups (111-L, 111-M, and 111-S) on the basis of this range definition. Note that the numerical values of the excitation coefficients are large in order of L, M, and S. The element antenna (111-S) classified into S in which the numerical value of the excitation amplitude is the smallest takes not only a numerical value of an amplitude coefficient that is close to a machine epsilon (a minimum limit value that can be supported by computers), but also has such an amplitude of a beam to be excited that the amplitude is smaller than resolution of an ADC or a DAC constituting the signal processing device. A beam signal whose amplitude is smaller than the resolution of the DAC or the like cannot be actually supported.

The element antenna 111 (111-L or 111-M) whose numerical value of the excitation coefficient has been classified into L or M has a relatively great excitation amplitude and greatly contributes to an entire beam. The numerical value of the excitation coefficient of “the element that greatly contributes to the beam” at a time of “selection of the element that greatly contributes to the beam (ST2) is classified into, for example, L or M.

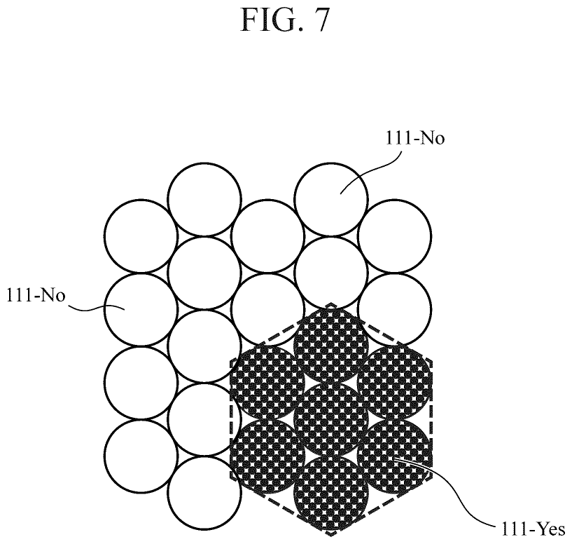

FIG. 7 is an explanatory view illustrating processing of selecting the element antenna 111 that greatly contributes to an entire beam on the basis of the magnitude of amplitude scaling. The seven element antennas 111 (111—Yes) illustrated in FIG. 7 are the element antennas 111 (111-L or 111-M) whose numerical values of the excitation coefficients have been classified into L or M as elements that greatly contribute to an entire beam. On the other hand, the rest of the element antennas 111 (111—No) illustrated in FIG. 7 are removed from selection of the elements that greatly contribute to the entire beam.

As illustrated in FIG. 7, the one or more element antennas 111 (111—Yes) selected as the elements that greatly contribute to the entire beam also constitute one element antenna group.

A result obtained by selecting the elements that greatly contribute to the entire beam on the basis of the magnitude of amplitude scaling may sufficiently match with a selection result of the “geometrical-optical element selection method”.

“Selection of the element that greatly contributes to the beam (ST2)” is performed by the element selection function (150-F2) of the excitation coefficient computation unit 150.

“Calculation of the conditional excitation coefficient (ST3)” is mainly a processing step performed by the excitation coefficient computation unit 150. The excitation coefficient computation unit 150 executes the DBF algorithm using only the element antennas 111 (111—Yes) selected as the elements that greatly contribute to the entire beam this time at the time of “calculation of the conditional excitation coefficient (ST3)”. That is, “conditional” means that only the element antennas 111 (111—Yes) selected as the elements that greatly contribute to the entire beam are used.

To put it simply, the DBF algorithm optimizes the complex weight (w_{m,n}) that uses an evaluation function. That is, it can be said that the excitation coefficient computation unit 150 optimizes the complex weight (w_{m,n}) that conditionally uses the evaluation function at the time of “calculation of the conditional excitation coefficient (ST3)”. This processing step is performed by the selected element excitation coefficient computation function (150-F3) of the excitation coefficient computation unit 150.

“Calculation of the conditional excitation coefficient (ST3)” is not an absolutely necessary processing step. This is because there is no significant difference between the complex weight (w_{m,n}) calculated under a condition that all of the element antennas 111 connected to the array-fed unit 110 are used, and the complex weight (w_{m, n}) calculated under a condition that only the element antennas 111 (111—Yes) selected as the elements that greatly contribute to the entire beam.

This is easy to understand when a following example where the circle ratio π is approximated by finite terms is taken into account.

$$n ≅ 3 + 1 ( 1 {0}^{- 1} ) + 4 ( 1 {0}^{- 2} ) + 1 ( 1 {0}^{- 3} ) + 5 ( 1 {0}^{- 4} ) + 9 ( {10}^{- 5} ) \qquad ( 3 )$$

The equation (3) is an example where π is approximated by six finite terms, and coefficients are {3, 1, 4, 1, 5, 9}.

Next, under a condition that the number of finite terms is limited to five, an approximation formula of π is expressed as follows.

$$π ≅ {\overbrace{3 + 1 ( 1 {0}^{- 1} ) + 4 ( 1 {0}^{- 2} ) + 1 ( 1 {0}^{- 3} )}}^{s ame} + {\overbrace{6}}^{round} ( {10}^{- 6} ) \qquad ( 4 )$$

Coefficients indicated in the equation (4) are {3, 1, 4, 1, 6}. In this example, a difference between the equation (3) and the equation (4) is only a portion that changes from “5₉” to “6₀” due to an influence of rounding.

As described above, generally speaking, optimization computation does not need to be performed again when reduced order approximation (also referred to simply as “lower dimensional approximation”) is performed.

In a technical field of a radar system, there is a known device that employs a general configuration of a DBF system of searching for a target, and calculates an eigenvalue and an eigenvector of a main beam correlation matrix (see, for example, the following reference patent literature).
Reference Patent Literature: JP 2009-204501 A

The above reference patent literature describes that, when D eigenvalues whose values are relatively large are focused upon and D eigenvectors corresponding to the D eigenvalues are selected, Mth dimensional partial space is approximated by smaller dimensionality D. This idea is essentially common to a method that is known as “low-rank approximation by singular value decomposition”.

The array-fed reflector antenna 100 according to the technology of the present disclosure may perform signal processing using the above main beam correlation matrix. Note that, in this case, too, generally speaking, the optimization computation does not need to be performed again when lower dimensional approximation is performed.

One of technical features of the array-fed reflector antenna 100 according to Embodiment 1 is that the signal processing device (the signal processing unit 140, the excitation coefficient computation unit 150, and the communication request generation unit 160) adopts the DBF system.

The array-fed reflector antenna 100 according to Embodiment 1 has this technical feature, and consequently can scan a beam at an ultra high speed, and perform detailed antenna pattern shaping such as ultra-side lobe reduction, so that it is possible to enjoy an advantage of DBF that it is easy to execute a plurality of beam formation computations of different orientation directions in parallel.

Another technical feature of the array-fed reflector antenna 100 according to Embodiment 1 is that the excitation coefficient computation unit 150 of the signal processing device has the element selection function (150-F2) and the selected element excitation coefficient computation function (150-F3).

The array-fed reflector antenna 100 according to Embodiment 1 has this technical feature, and consequently can reduce the number of connection elements to be connected to the transceiver. This means that, when, for example, an RF circuit connected to an element antenna removed from selection of the elements that greatly contribute to an entire beam causes a failure, it is possible to provide an effect that it is possible to eliminate a risk that an unnecessary component is erroneously output.

Furthermore, this technical feature also provides an effect that it is possible to reduce a necessary amount of complex weights to be stored and transmitted, and reduce computation processing of multiplication of the complex weights on a received digital signal at a time of DBF. This effect is very important in a scene that communication is performed between a ground station and a satellite station.

### Embodiment 2

An array-fed reflector antenna 100 according to Embodiment 2 is a modification example of the array-fed reflector antenna 100 according to the technology of the present disclosure. Unless otherwise specifically indicated, the same reference numerals as those used in Embodiment 1 will be used in Embodiment 2. Furthermore, Embodiment 2 will omit description that overlaps those in Embodiment 1 as appropriate.

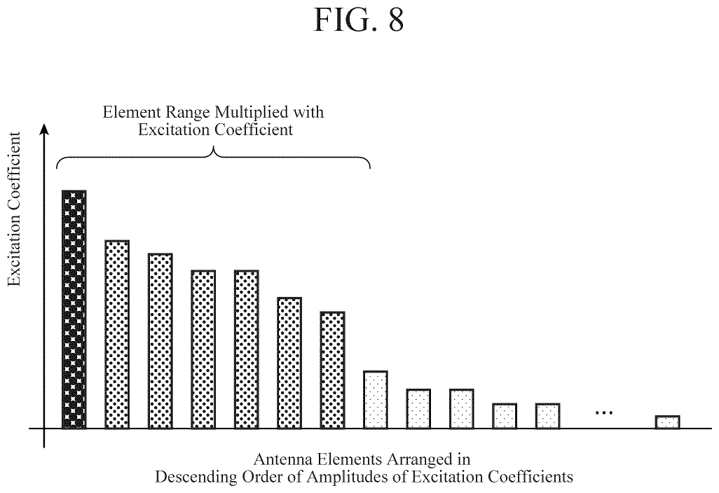

FIG. 8 shows a vertical bar graph for describing a signal processing method of the array-fed reflector antenna 100 according to Embodiment 2. In the vertical bar graph illustrated in FIG. 8, the horizontal axis indicates “antenna elements arranged in descending order of amplitudes of excitation coefficients”, and the vertical axis indicates an “excitation coefficient”. More strictly speaking, the vertical axis in the graph shown in FIG. 8 indicates the numerical value of the excitation coefficient, that is, an absolute value of the complex weight (w_{m,n}) that is a complex number, and is also a numerical value of a_{m,n} that is a parameter related to amplitude scaling.

A technical feature unique to the array-fed reflector antenna 100 according to Embodiment 2 is that the number of connection elements to be connected to the transceiver is fixed and determined in advance by the signal processing method. In the example illustrated in FIG. 8, an element range to be connected to the transceiver is illustrated as an “element range to be multiplied on an excitation coefficient”, and the number of connection element is seven.

This method is common to an idea that, at a time of general reduced dimension approximation, the dimensionality after dimension reduction is fixed and determined in advance irrespectively of the magnitude of an approximation error.

In this description, the number of connection elements fixed and determined in advance can be represented by N_{m,low} per beam signal (m=1, . . . , and M). N_{m,low} may be a different value per beam signal (m=1, . . . , and M), or may be one common number for all beam signals.

In a case where N_{m,low} is a different value per beam signal (m=1, . . . , and M), it can be expected that the number of connection elements is minimized as a whole.

In a case where N_{m,low} is one common number, it can be expected that beam signal processing can be commonalized, and improvement of efficiency can be expected. In this case, for example, a processing step of passing information of N_{m,low} from the excitation coefficient computation unit 150 to the DBF unit 141 is unnecessary. Furthermore, in this case, a circuit scale of the DBF unit 141 does not differ per beam signal, so that, when versatility does not need to be provided, an efficient circuit design of the signal processing unit 140 can be expected.

### Embodiment 3

An array-fed reflector antenna 100 according to Embodiment 3 is a modification example of the array-fed reflector antenna 100 according to the technology of the present disclosure. Unless otherwise specifically indicated, the same reference numerals as those used in the previously described embodiments will be used in Embodiment 3. Furthermore, Embodiment 3 will omit description that overlaps those in the previously described embodiments as appropriate.

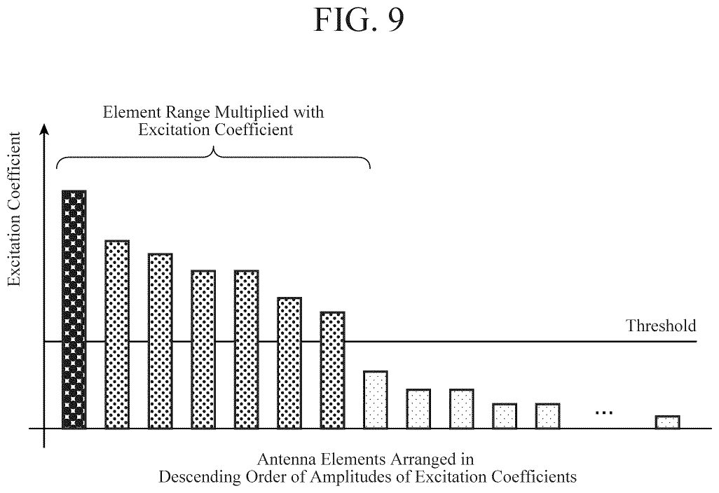

FIG. 9 shows a vertical bar graph for describing a signal processing method of the array-fed reflector antenna 100 according to Embodiment 3. A difference between FIGS. 8 and 9 is that a line of a threshold is added to the vertical bar graph illustrated in FIG. 9.

As described above, the array-fed reflector antenna 100 according to the technology of the present disclosure may connect to the transceiver only the element antennas 111 whose numerical values of excitation coefficients exceed a threshold using the threshold prepared in advance.

This idea is common to, for example, a method of selecting only a singular value that exceeds the threshold at a time of low rank approximation by singular value decomposition.

This threshold may be, for example, a value determined on the basis of simulation, experience, or statistics.

It can be said that an effect unique to a method of determining an element to be connected to the transceiver on the basis of the threshold determined on the basis of the statistics or the like is that it is possible to evaluate an approximation error in advance.

### Embodiment 4

An array-fed reflector antenna 100 according to Embodiment 4 is a modification example of the array-fed reflector antenna 100 according to the technology of the present disclosure. Unless otherwise specifically indicated, the same reference numerals as those used in the previously described embodiments will be used in Embodiment 4. Furthermore, Embodiment 4 will omit description that overlaps those in the previously described embodiments as appropriate.

As described in Embodiment 1, a result obtained by selecting elements that greatly contribute to an entire beam on the basis of the magnitude of amplitude scaling substantially matches with the selection result of the “geometrical-optical element selection method” (see, for example, FIGS. 6 and 7). The inventors of the present invention according to the technology of the present disclosure have empirically found that there is a relatively large discontinuous step between a numerical value of an excitation coefficient of an element selected by the “geometrical-optical element selection method”, and a numerical value of an excitation coefficient of an element removed from selection by the “geometrical-optical element selection method”. This is also shown in the bar graph illustrated in FIG. 9. The seven upper element antennas 111 shown in the graph in FIG. 9 correspond to the one element antenna 111-L and the six element antennas 111-M illustrated in FIG. 6.

The signal processing method of the array-fed reflector antenna 100 according to the technology of the present disclosure may arrange numerical values of excitation coefficients in descending order, and compare a difference between numerical values of neighboring excitation coefficients and a threshold (ε_{w}).

$$\begin{matrix}{W}_{Low} := \{ {W}_{1} … {W}_{{N}_{Low}} \} \\ wherein \\ for n = 1 to {N}_{Low} - 1 \\ \vert {W}_{n} \vert - \vert {W}_{n + 1} \vert < {ε}_{w} \\ and \\ \vert {W}_{{N}_{Low}} \vert - \vert {W}_{{N}_{Low} + 1} \vert \geq {ε}_{w}\end{matrix} \qquad ( 5 )$$

In this regard, n that is an identification number of the element antenna 111 appearing the equation (5) represents a serial number in a case where numerical values of excitation coefficients are arranged in descending order. N_{Low} (in this regard, N_{Low}<N holds) appearing in the equation (5) is the number of elements to be connected to the transceiver after dimension reduction. W_{Low} represents a set of complex weights related to elements to be connected to the transceiver after dimension reduction. Furthermore, for simplicity of description, a beam signal is only a first beam signal (m=1 and M=1) in the equation (5).

An effect unique to the array-fed reflector antenna 100 according to Embodiment 4 is that it is possible to easily obtain a substantially equal boundary to a boundary of an element range that can be obtained by the “geometrical-optical element selection method”.

### Embodiment 5

An array-fed reflector antenna 100 according to Embodiment 5 is a modification example of the array-fed reflector antenna 100 according to the technology of the present disclosure. Unless otherwise specifically indicated, the same reference numerals as those used in the previously described embodiments will be used in Embodiment 5. Furthermore, Embodiment 5 will omit description that overlaps those in the previously described embodiments as appropriate.

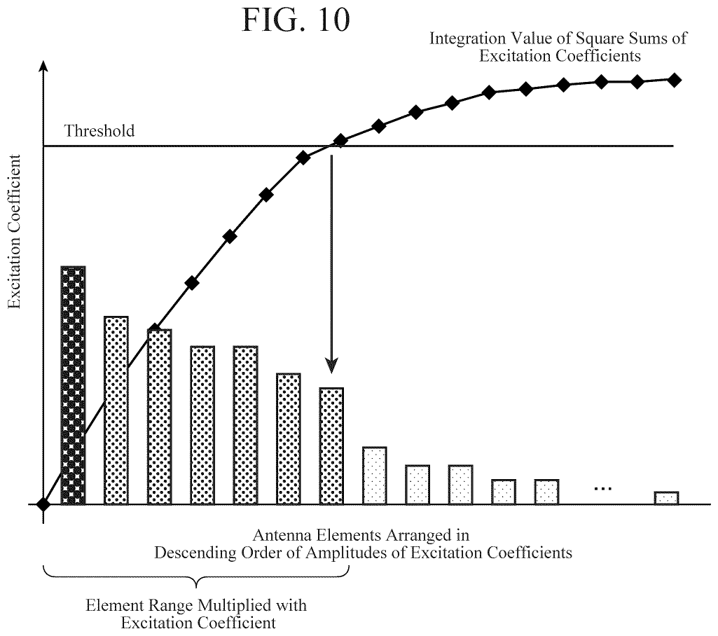

FIG. 10 shows a vertical bar graph for describing a signal processing method of the array-fed reflector antenna 100 according to Embodiment 5. A difference between FIGS. 9 and 10 is that there is a plot curve described as “an integration value of square sums of excitation coefficients” in the vertical bar graph illustrated in FIG. 10, and a line of a threshold different from that in FIG. 9 is added.

The signal processing method of the array-fed reflector antenna 100 according to the technology of the present disclosure may determine elements to be connected to the transceiver, focusing an integration value (integrated value) of numerical values of excitation coefficients.

$$\begin{matrix}{W}_{Low} := \{ {W}_{1} … {W}_{{N}_{Low}} \} \\ wherein \\ {\sum }_{n = 1}^{{N}_{Low} - 1} \vert {W}_{n} \vert < {ε}_{sum} \\ and \\ {\sum }_{n = 1}^{{N}_{Low} - 1} \vert {W}_{n} \vert \geq {ε}_{sum}\end{matrix} \qquad ( 6 )$$

In this regard, similarly to the equation (5), n that is an identification number of the element antenna 111 appearing in the equation (6) represents a serial number in a case where numerical values of excitation coefficients are arranged in descending order. εₛᵤₘ appearing in the equation (6) is a threshold for an integration value of numerical values of excitation coefficients.

Although the numerical value of the excitation coefficient takes a positive value as described above, a following conditional expression may be used instead of the equation (6).

$$\begin{matrix}{W}_{Low} := \{ {W}_{1} … {W}_{{N}_{Low}} \} \\ wherein \\ {\sum }_{n = 1}^{{N}_{Low} - 1} {a}_{n}^{2} < {ε}_{sum 2} \\ and \\ {\sum }_{n = 1}^{{N}_{Low}} {a}_{n}^{2} \geq {ε}_{sum 2}\end{matrix} \qquad ( 7 )$$

In this regard, an appearing in the equation (7) is an that is a parameter related to amplitude scaling appearing in the equation (1). εₛᵤₘ₂ appearing in the equation (7) is a threshold for a square sum of numerical values of excitation coefficients. A threshold shown in the graph in FIG. 10 is this εₛᵤₘ₂.

The threshold (εₛᵤₘ₂) for the square sum of the numerical values of the excitation coefficients may be determined on the basis of a square sum of numerical values of excitation coefficients related to a total number of elements. In a case where, for example, the threshold (εₛᵤₘ₂) for the square sum of the numerical values of the excitation coefficients is determined as 90% of the square sum of the numerical values of the excitation coefficients related to the total number of elements, εₛᵤₘ₂ is given by a following mathematical formula.

$${ε}_{sum 2} := 0.9 \times {\sum }_{n = 1}^{N} {a}_{n}^{2} \qquad ( 8 )$$

Furthermore, the threshold (εₛᵤₘ₂) for the square sum of the numerical values of the excitation coefficients is determined as 50% of the square sum of the numerical values of the excitation coefficients related to the total number of elements, εₛᵤₘ₂ is given by a following mathematical formula.

$${ε}_{sum 2} := 0.5 \times {\sum }_{n = 1}^{N} {a}_{n}^{2} \qquad ( 9 )$$

A relatively great discontinuous step described in Embodiment 4 appears as a breaking point in the plot curve of “the integration value of the square sums of the excitation coefficients” (see FIG. 10). Accordingly, the signal processing device (the signal processing unit 140, the excitation coefficient computation unit 150, and the communication request generation unit 160) of the array-fed reflector antenna 100 may determine elements to be connected to the transceiver using a property that this breaking point appears.

As indicated in the equation (8) or the equation (9), a method of determining a threshold (εₛᵤₘ₂) at a rate with respect to a square sum of numerical values of excitation coefficients related to the total number of elements provides an effect that it is possible to evaluate an approximation error in advance.

### INDUSTRIAL APPLICABILITY

The array-fed reflector antenna according to the technology of the present disclosure can be applied to, for example, an antenna mounted on a satellite that implements multibeam satellite communication, and has great industrial applicability.

### REFERENCE SIGNS LIST

100: Array-fed reflector antenna, 110: Array-fed unit (Array feeder), 111: Element antenna, 120: Reflector unit, 130: RF Circuit unit, 140: Signal processing unit, 141: DBF unit, 142: Distributor, 143: Adder, 144: Excitation coefficient storage unit, 145: Element signal adder, 146: Excitation coefficient multiplier, 150: Excitation coefficient computation unit (Excitation coefficient calculator), 160: Communication request generation unit

What is claimed is:

1. A signal processing device for an array-fed reflector antenna of a DBF system, the signal processing device comprising
an excitation coefficient calculator,
wherein on an assumption that all element antennas connected to an array feeder are used, the excitation coefficient calculator executes a DBF algorithm for all of the element antennas, and calculates an excitation coefficient for each of the element antennas,
wherein the excitation coefficient calculator selects an element antenna that greatly contributes to a beam among the element antennas on a basis of a numerical value of the excitation coefficient, and
wherein the excitation coefficient calculator compares a difference between numerical values of neighboring excitation coefficients and a threshold (ε_{w}) with the element antennas arranged in descending order of numerical values of excitation coefficients, and selects an element antenna that satisfies a following conditional expression
$$\begin{matrix}{W}_{Low} := \{ {W}_{1} … {W}_{{N}_{Low}} \} \\ wherein \\ for n = 1 to {N}_{Low} - 1 \\ \vert {W}_{n} \vert - \vert {W}_{n + 1} \vert < {ε}_{w} \\ and \\ \vert {W}_{{N}_{Low}} \vert - \vert {W}_{{N}_{Low} + 1} \vert \geq {ε}_{w}\end{matrix} \qquad ( 5 )$$
among the element antennas.

2. A signal processing device for an array-fed reflector antenna of a DBF system, the signal processing device comprising
an excitation coefficient calculator,
wherein on an assumption that all element antennas connected to an array feeder are used the excitation coefficient calculator executes a DBF algorithm for all of the element antennas, and calculates an excitation coefficient for each of the element antennas,
wherein the excitation coefficient calculator selects an element antenna that greatly contributes to a beam among the element antennas on a basis of a numerical value of the excitation coefficient, and
wherein the excitation coefficient calculator calculates an integration value of numerical values of excitation coefficients with the element antennas arranged in descending order of the numerical values of the excitation coefficients, and selects an element antenna that satisfies a following conditional expression
$$\begin{matrix}{W}_{Low} := \{ {W}_{1} … {W}_{{N}_{Low}} \} \\ wherein \\ {\sum }_{n = 1}^{{N}_{Low} - 1} \vert {W}_{n} \vert < {ε}_{sum} \\ and \\ {\sum }_{n = 1}^{{N}_{Low} - 1} \vert {W}_{n} \vert \geq {ε}_{sum}\end{matrix} \qquad ( 6 )$$
among the element antennas.

3. A signal processing device for an array-fed reflector antenna of a DBF system, the signal processing device comprising
an excitation coefficient calculator,
wherein on an assumption that all element antennas connected to an array feeder are used, the excitation coefficient calculator executes a DBF algorithm for all of the element antennas, and calculates an excitation coefficient for each of the element antennas,
wherein the excitation coefficient calculator selects an element antenna that greatly contributes to a beam among the element antennas on a basis of a numerical value of the excitation coefficient, and
wherein the excitation coefficient calculator calculates a square sum of numerical values of excitation coefficients with the element antennas arranged in descending order of the numerical values of the excitation coefficients, and selects an element antenna that satisfies a following conditional expression
$$\begin{matrix}{W}_{Low} := \{ {W}_{1} … {W}_{{N}_{Low}} \} \\ wherein \\ {\sum }_{n = 1}^{{N}_{Low} - 1} {a}_{n}^{2} < {ε}_{sum 2} \\ and \\ {\sum }_{n = 1}^{{N}_{Low}} {a}_{n}^{2} \geq {ε}_{sum 2}\end{matrix} \qquad ( 7 )$$
among the element antennas.

4. The signal processing device for the array-fed reflector antenna according to claim 3, wherein the excitation coefficient calculator adopts
$${ε}_{sum 2} := 0.9 \times {\sum }_{n = 1}^{N} {a}_{n}^{2} \qquad ( 8 )$$
as a threshold (εₛᵤₘ₂) of the conditional expression.

5. The signal processing device for the array-fed reflector antenna according to claim 3, wherein the excitation coefficient calculator adopts
$${ε}_{sum 2} := 0.5 \times {\sum }_{n = 1}^{N} {a}_{n}^{2} \qquad ( 9 )$$
as a threshold (εₛᵤₘ₂) of the conditional expression.

6. An array-fed reflector antenna comprising the signal processing device according to claim 1.

7. A signal processing method for an array-fed reflector antenna of a DBF system, the signal processing method comprising:
executing a DBF algorithm for all element antennas on an assumption that all of the element antennas connected to an array feeder are used, and calculating an excitation coefficient for each of the element antennas;
selecting an element antenna that greatly contributes to a beam among the element antennas on a basis of a numerical value of the excitation coefficient; and
arranging the element antennas in descending order of numerical values of excitation coefficients, comparing a difference between numerical values of neighboring excitation coefficients and a threshold (ε_{w}), and selecting an element antenna that satisfies a following conditional expression
$$\begin{matrix}{W}_{Low} := \{ {W}_{1} … {W}_{{N}_{Low}} \} \\ wherein \\ for n = 1 to {N}_{Low} - 1 \\ \vert {W}_{n} \vert - \vert {W}_{n + 1} \vert < {ε}_{w} \\ and \\ \vert {W}_{{N}_{Low}} \vert - \vert {W}_{{N}_{Low} + 1} \vert \geq {ε}_{w}\end{matrix} \qquad ( 5 )$$
among the element antennas.

8. A signal processing method for an array-fed reflector antenna of a DBF system, the signal processing method comprising:
executing a DBF algorithm for all element antennas on an assumption that all of the element antennas connected to an array feeder are used, and calculating an excitation coefficient for each of the element antennas;
selecting an element antenna that greatly contributes to a beam among the element antennas on a basis of a numerical value of the excitation coefficient; and
arranging the element antennas in descending order of numerical values of excitation coefficients, calculating an integration value of the numerical values of the excitation coefficients, and selecting an element antenna that satisfies a following conditional expression
$$\begin{matrix}{W}_{Low} := \{ {W}_{1} … {W}_{{N}_{Low}} \} \\ wherein \\ {\sum }_{n = 1}^{{N}_{Low} - 1} \vert {W}_{n} \vert < {ε}_{sum} \\ and \\ {\sum }_{n = 1}^{{N}_{Low} - 1} \vert {W}_{n} \vert \geq {ε}_{sum}\end{matrix} \qquad ( 6 )$$
among the element antennas.

9. A signal processing method for an array-fed reflector antenna of a DBF system, the signal processing method comprising:
executing a DBF algorithm for all element antennas on an assumption that all of the element antennas connected to an array feeder are used, and calculating an excitation coefficient for each of the element antennas;
selecting an element antenna that greatly contributes to a beam among the element antennas on a basis of a numerical value of the excitation coefficient; and
arranging the element antennas in descending order of numerical values of excitation coefficients, calculating a square sum of the numerical values of the excitation coefficients, and selecting an element antenna that satisfies a following conditional expression
$$\begin{matrix}\begin{matrix}{W}_{Low} := \{ {W}_{1} … {W}_{{N}_{Low}} \} \\ wherein \\ {\sum }_{n = 1}^{{N}_{Low} - 1} {a}_{n}^{2} < {ε}_{sum 2} \\ and \\ {\sum }_{n = 1}^{{N}_{Low}} {a}_{n}^{2} \geq {ε}_{sum 2}\end{matrix} & ( 7 )\end{matrix}$$
among the element antennas.

10. The signal processing method according to claim 9, wherein a threshold (εₛᵤₘ₂) of the conditional expression is
$${ε}_{sum 2} := 0.9 \times {\sum }_{n = 1}^{N} {a}_{n}^{2} \qquad ( 8 )$$

11. The signal processing method according to claim 9, wherein a threshold (εₛᵤₘ₂) of the conditional expression is
$${ε}_{sum 2} := 0.5 \times {\sum }_{n = 1}^{N} {a}_{n}^{2} \qquad ( 9 )$$
